(19) United States
(12) Patent Application Publication
(10) Pub. No.: US 2016/0332186 A1
(43) Pub. Date: Nov. 17, 2016

(54) Hot-Melt Apparatus and Method

(71) Applicant: David Richards, Pflugerville, TX (US)

(72) Inventor: David Richards, Pflugerville, TX (US)

(21) Appl. No.: 15/153,696

(22) Filed: May 12, 2016

Related U.S. Application Data
(60) Provisional application No. 62/161,099, filed on May 13, 2015.

(51) Int. Cl. B05C 11/10; B05B 13/00

(52) U.S. Cl. CPC B05C 11/1042; B05C 11/1026; B05B 13/005

(57) ABSTRACT

In some embodiments, an apparatus may include a frame having at least two wheels and a handle and may include a tank mounted to the frame and configured to melt a hot-melt material. The apparatus may further include a hot-melt delivery system coupled to the tank and configured to selectively deliver the hot-melt material in a fluid form to an output and a filter configured to prevent solid material from entering the hot-melt delivery system.

### CROSS-REFERENCE TO RELATED APPLICATION(S)

The present application is a non-provisional of and claims priority to U.S. Provisional Patent Application No. 62/161,099, filed on May 13, 2015 and entitled “Hot-Melt Apparatus and Method”, which is incorporated herein by reference in its entirety.

### FIELD

The present disclosure is generally related to thermo-melt devices, and more particularly to thermo-melt devices configured to melt and distribute melted material to a designated surface.

### BACKGROUND

Driveways, patios, and other surfaces may be formed of rigid materials, such as concrete. To mitigate cracking due to temperature fluctuations, expansion joints or grooves are often cut between slabs to allow for thermal expansion. Unfortunately, moisture may sometimes seep into such expansion joints, and such moisture may cause damage, such as cracking of the rigid material or erosion of the underlying material, which erosion may undermine the stability of the surface and lead to further cracking.

### SUMMARY

In some embodiments, an apparatus may include a frame including at least two wheels and a handle. The frame may be configured to be moveable. The apparatus may further include a hot-melt tank mounted to the frame and configured to hold a hot-melt material, a heating element associated with the hot-melt tank, and a controller coupled to the heating element. The apparatus may also include a hot-melt delivery system coupled to the hot-melt tank and configured to selectively deliver the hot-melt material in a fluid form to an output.

In other embodiments, an apparatus may include a hot-melt tank configured to hold a hot-melt material in a fluid form. The apparatus may further include a hot-melt delivery system configured to provide the hot-melt material to a substrate.

In some embodiments, an apparatus may include a frame having at least two wheels and a handle and may include a tank mounted to the frame and configured to melt a hot-melt material. The apparatus may further include a hot-melt delivery system coupled to the tank and configured to selectively deliver the hot-melt material in a fluid form to an output and a filter configured to prevent solid material from entering the hot-melt delivery system.

In other embodiments, an apparatus may include a frame including at least two wheels and a handle. The frame may be configured to be portable. The apparatus may also include a tank coupled to the frame and configured to hold a hot-melt material in a fluid form and a filter disposed within the tank and configured to separate solid material from the hot melt material in the fluid form. The apparatus may further include a hot-melt delivery system coupled to the tank and configured to selectively provide the hot-melt material to a substrate.

In still other embodiments, an apparatus may include a frame having at least two wheels and a handle. The frame may be configured to be portable. The apparatus may further include a tank coupled to the frame and configured to hold a hot-melt material in a fluid form. The tank may include a heating element and one or more sensors. The apparatus may also include a hot-melt delivery system coupled to the tank and configured to selectively provide the hot-melt material to a substrate, and may include a controller coupled to the heating element, the one or more sensors, and the hot-melt delivery system. The controller may be configured to selectively enable the hot-melt delivery system when the hot-melt material reaches at least one of a selected temperature and a selected viscosity.

### BRIEF DESCRIPTION OF THE DRAWINGS

FIG. 1 is a block diagram of an apparatus configured to distribute a thermo-melt material, in accordance with some embodiments of the present disclosure.

FIG. 2 is a block diagram of an apparatus configured to distribute a thermo-melt material, in accordance with some embodiments of the present disclosure.

FIG. 3 is a perspective view of an apparatus configured to distribute a thermo-melt material, in accordance with some embodiments of the present disclosure.

FIG. 4 is a block diagram of an apparatus configured to distribute a thermo-melt material, in accordance with some embodiments of the present disclosure.

FIG. 5A is a side-view of a pour pot for distributing a thermo-melt material, in accordance with some embodiments of the present disclosure.

FIG. 5B is a front view of the pour pot of FIG. 5A including a lid in an open position, in accordance with some embodiments of the present disclosure.

FIG. 5C is a front view of the pour pot of FIG. 5A including a lid in a closed position, in accordance with some embodiments of the present disclosure.

FIG. 6 is a flow diagram of a method distributing a hot-melt material, in accordance with some embodiments of the present disclosure.

FIG. 7A is a cross-sectional view of a thermo-melt material, in accordance with some embodiments of the present disclosure.

FIG. 7B is a top view of a thermo-melt material having a tape-strip profile, in accordance with some embodiments of the present disclosure.

FIG. 7C is a side view of a roll of thermo-melt material having a tape-strip profile, in accordance with some embodiments of the present disclosure.

FIG. 7D is a top view of a sheet of thermo-melt material including perforations, in accordance with some embodiments of the present disclosure.

FIG. 8A is a perspective view of a box having a non-stick liner and including thermo-melt material, in accordance with some embodiments of the present disclosure.

FIG. 8B is a perspective view of a box having a non-stick liner and including multiple layers of thermo-melt material, in accordance with some embodiments of the present disclosure.

In the following discussion, the same reference numbers are used in the various embodiments to indicate the same or similar elements.

### DETAILED DESCRIPTION OF ILLUSTRATIVE EMBODIMENTS

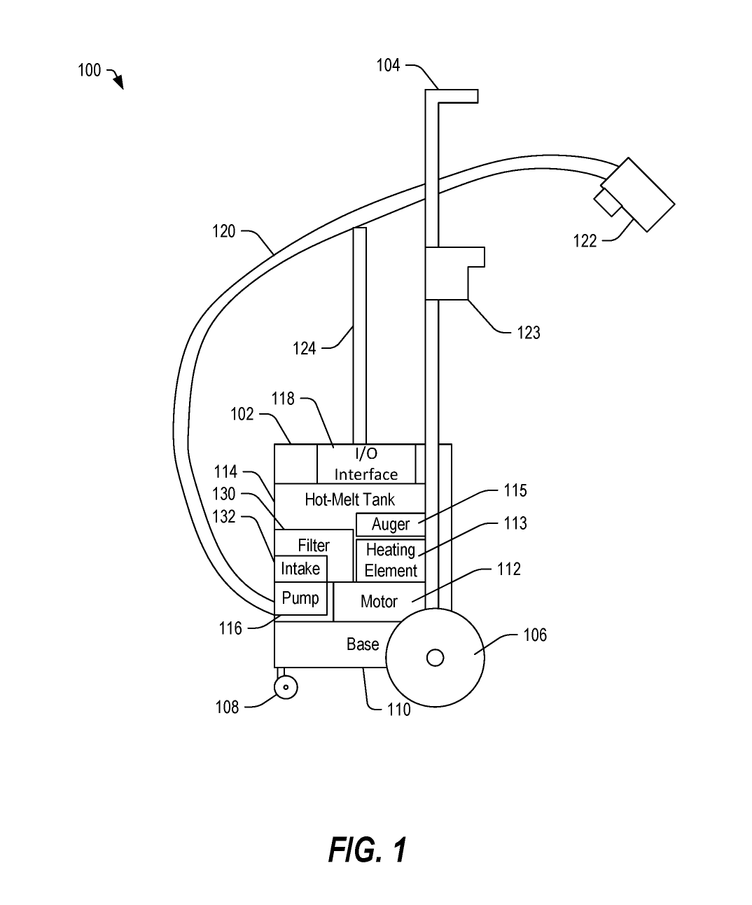

Embodiments of apparatuses and methods are described below that may be used to distribute a hot-melt material to a surface, such as to a crack in a driveway, an expansion joint, or another surface. In some embodiments, prior to application of the hot-melt material, debris may be removed from the crack or expansion joint and surfaces associated with the crack or expansion joint may be prepared (cleaned) to receive the hot-melt material. In some embodiments, an apparatus may include a hot-melt tank sized to receive hot-melt material, and a heating element may apply heat to change the hot-melt material from a solid phase to a liquid phase. The apparatus may further include a pump and a dispensing mechanism configured to selectively deliver the hot-melt material (in liquid form) to the surface. In some embodiments, the apparatus may be a pour pot including a hot-melt tank and a pour spout for distribution of the hot-melt material to a surface. One possible example of an apparatus to distribute hot-melt material is described below with respect to FIG. 1.

FIG. 1 is a block diagram of an apparatus 100 configured to distribute a thermo-melt material, in accordance with some embodiments of the present disclosure. The apparatus 100 may include a frame 102 coupled to a handle 104. The frame 102 may include rear wheels 106 and front wheels 108, which may be coupled to a base 110. The base 110 may support a motor 112, a hot-melt tank 114, a pump 116, and an input/output (I/O) interface 118. The pump 116 may be an auger or screw-type pump that may be designed to withstand cycled heating and cooling. The pump 116 may be coupled to a dispensing nozzle 122 through a dispensing tube 120. The apparatus 100 may further include a support arm 124 configured to secure the dispensing tube 120 when not in use. Further, a holster 123 may be provided on the support arm 124 or on the handle 104 (as shown) to secure the dispensing nozzle 122 when not in use.

In some embodiments, hot-melt material may be placed in the hot-melt tank (reservoir) 114, and a user may interact with one or more user-selectable elements of the I/O interface 118 to activate the motor 112. In some embodiments, the motor 112 may include or may be coupled to a heating element 113 and which may be configured to apply heat to the hot-melt tank 114 to melt the hot-melt material (such as a thermo-rubber). The I/O interface 118 or the hot-melt tank 114 may include one or more sensors configured to measure a temperature of the hot-melt material in the tank 114. Additionally, the apparatus 100 may include an auger 115 or other element within the hot-melt tank 114 configured to stir or otherwise agitate the hot-melt material in order to facilitate the melting process and to maintain a substantially consistent heating throughout the hot-melt material in the tank 114. In some embodiments, an auger-type pump mechanism may be positioned at least partially within the hot-melt tank 114 and may be configured to drive the melted hot-melt material through a filter 130, into an intake 132, and through the dispensing tube 120 to the nozzle 122.

In a particular example, the filter 130 may be formed from a metal mesh and may be designed to have openings sized to prevent unmelted rubber or contaminants within the melted material (such as pebbles, glass, or other thermally resistive materials) from reaching the pump 116 or the dispensing tube 120. In an embodiment, the filter 130 may be a screen or mesh made of wire. In a particular embodiment, the wire mesh may be quarter-inch wire. The filter 130 may be placed at or near the bottom of the tank 114 to capture any solid objects so that those objects are not sucked into the pump.

Further, in some examples, the motor 112 may power a drive shaft that may extend through an opening and into the tank 114. A bushing element may be positioned within the opening to keep heat in and to keep foreign objects out of the tank.

In some embodiments, tank 114 may include one or more viscosity sensors configured to determine a viscosity of the hot-melt material and optionally one or more temperature sensors. Alternatively, viscosity of the hot-melt material may be determined based on the resistance met by the auger 115. When at least one of the temperature and the viscosity exceeds a pre-determined threshold, the I/O interface 118 may provide a visual indicator, such as a display readout, a green light, or other indicator, which may represent a state of the hot-melt material indicating that hot-melt material is in a liquid phase and that the apparatus 100 may be used to distribute the hot-melt material. A user may interact with the I/O interface 118 to activate the pump 116 and may utilize the nozzle 122 to selectively apply the hot-melt material to a substrate, such as an expansion joint between concrete slabs. In some embodiments, the nozzle 122 may include a trigger (not shown) that may be accessed to activate the pump 116 when depressed and to deactivate the pump 116 when released. In some embodiments, the I/O interface 118 may include one or more controls accessible by a user to configure temperature settings of the apparatus 100. In some embodiments, the apparatus 100 may be configured to heat the tank 114 to a temperature selected based on a melt temperature of the hot-melt material, which temperature may vary based on the material properties of the selected hot-melt material.

In some embodiments, the apparatus 100 may include a power management unit and associated circuitry configured to receive power from a power supply, such as a 110 Volt alternating current wall socket. The power management unit may provide power to the motor 112, the pump 116, the auger 115, and the heating element 113. In some embodiments, the apparatus 100 may be configured to deliver hot-melt material in a liquid form to a substrate through the nozzle 122.

In some examples, the hot-melt material can be delivered by the nozzle 122 to concrete joints and cracks to fill the joint or crack. Further, the hot-melt material can be delivered by the nozzle 122 to adhere pavement markers, adhere sign posts, rumble strips, speed bumps, parking bumpers, temporary signs or most anything else to concrete, asphalt pavement, metal surfaces, or other rigid substrates.

In some embodiments, the hot-melt material may meet or exceed standards established by the American Society for Testing and Materials (ASTM), such as the ASTM C920-11 Standard Specification for elastomeric sealants, Type S, T1 for pedestrians and vehicular traffic. In some embodiments, the hot-melt material may not include volatile organic compounds (VOCs) and can be painted with acrylic, latex or epoxy coatings. In some embodiments, the hot-melt material may be applied in a liquid form and may cool within a few minutes, such that the hot-melt material can be traffic ready in about 5 minutes or less (for foot traffic, vehicle traffic, or any combination thereof). In some embodiments, the hot-melt material may be an elastomeric, self-leveling sealant, which liquefies quickly when heated and which can be used to seal cracks and expansion joints in concrete and asphalt surfaces. When properly applied, the hot-melt material may offer extraordinary resiliency to protect against the infiltration of moisture and may exhibit superior low temperature ductility and weather resistance. Further, the hot-melt material may have a low oxidation breakdown and may be resistant to tracking or marking from foot traffic, vehicle traffic, or both.

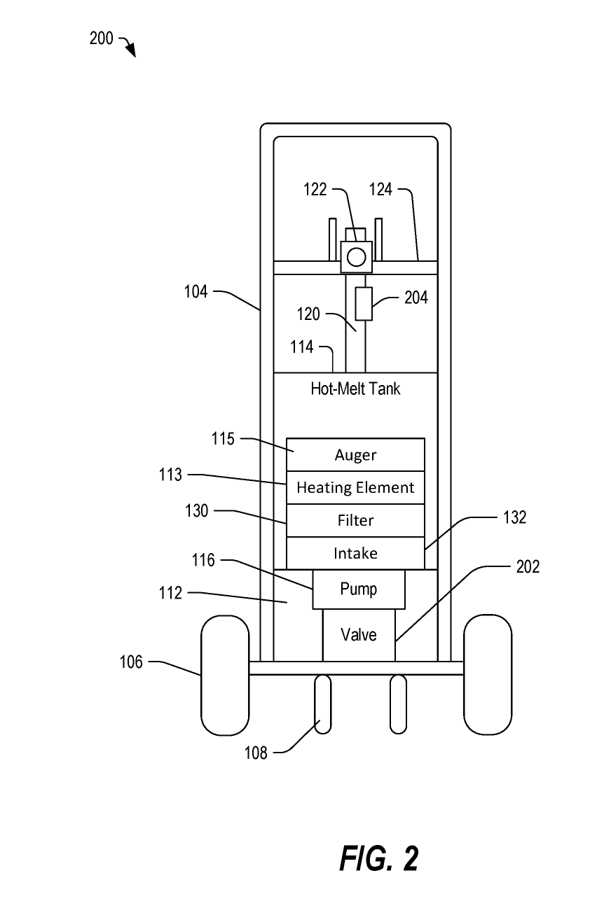

FIG. 2 is a block diagram of an apparatus 200 configured to distribute a thermo-melt material, in accordance with some embodiments of the present disclosure. The apparatus 200 may include all of the elements of the apparatus 100 of FIG. 1, and may further include a valve 202. The valve 202 may be positioned between the pump 116 and the hot-melt tank 114 or between the pump 116 and the dispensing tube 120.

In some embodiments, the pump 116 may include an auger 115 configured to push hot-melt fluid through a filter 130, into an intake 132, and into the dispensing tube 120 via the valve 202. The hot-melt tank 114 may include a heating element 113 as well as the auger 115 and the filter 130. The intake 132 may be an opening extending between the hot-melt tank 114 and the valve 202. In some embodiments, one or both of the nozzle 122 and the dispensing tube 120 may also include a heating element 204 configured to maintain the fluid temperature between the hot-melt tank 114 and the output of the nozzle 122.

The embodiments of the apparatus 100 in FIG. 1 and the apparatus 200 in FIG. 2 are shown with wheels 106 and 108, which allow the apparatus to be moved at the job site to deliver the melted material to a desired location. In some embodiments, the apparatus 100 or 200 may include two wheels and legs to allow the apparatus to be moved by tilting the apparatus and rolling it. In some embodiments, at least two of the wheels may be coupled to brake elements configured to releasably lock the associated wheel into a stationary state.

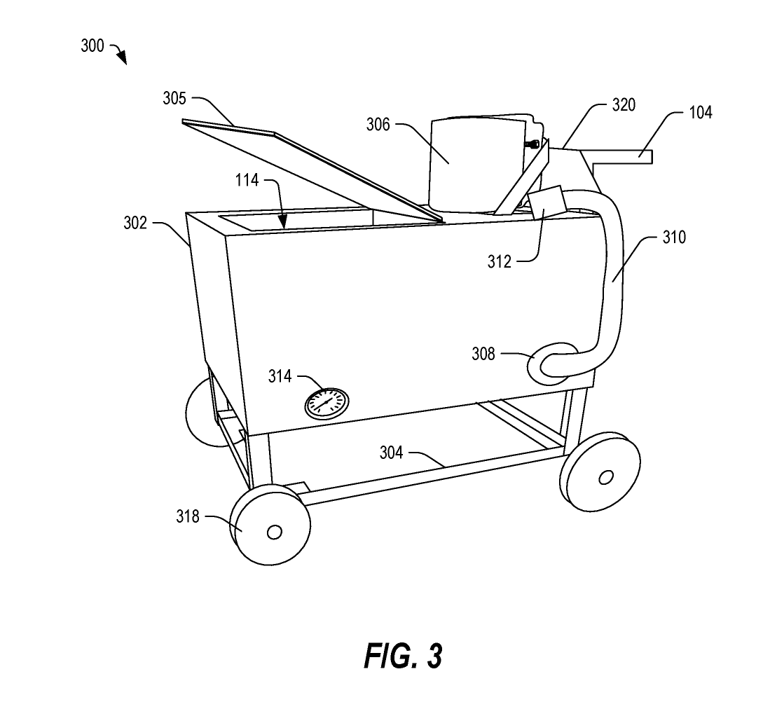

FIG. 3 is a perspective view of an apparatus 300 configured to distribute a thermo-melt material, in accordance with some embodiments of the present disclosure. The apparatus 300 may include a body 302 coupled to a frame 304, which may be mounted on wheels 318 and which may be coupled to a handle 104.

The apparatus 300 may include the hot-melt tank 114 including a cover 305 (not shown) and a motor 306, which may be configured to turn an auger in the hot-melt tank 114. The apparatus 300 may include a temperature gauge 314 and other gauges. In some embodiments, a hot-melt delivery system may be coupled to the hot-melt tank 114. In some examples, the hot-melt delivery system may include a seal 308, a hot-melt dispensing tube 310, and a nozzle 312. In some embodiments, the dispensing tube 310 and the nozzle 312 may include heating elements to maintain the hot-melt material at a temperature that is above a melt temperature of the hot-melt material. The body 302 may define a cavity sized to fit heating elements, sensors, circuits, and other elements, at least some of which may provide signals, receive signals, or both from a control interface coupled to at least one of the motor 306 and the handle 104.

In certain embodiments, the sides, bottom, and cover 305 of the hot melt tank 114 may be insulated to maintain the temperature of the hot-melt material. While the embodiment shown includes the motor 306 above the melt tank 114, in some embodiments, the motor 306 may be mounted lower and adjacent to the side of the melt tank 114. Additionally, though the seal 308 and hot-melt dispensing tube 310 are depicted on a side of the hot-melt system 300, in some embodiments, the seal 308 and the hot-melt dispensing tube 310 may be positioned on the end of the system 300 near the handle 104. In some embodiments, instead of a temperature gauge 314, the hot-melt system 300 may utilize digital temperature sensors, and the captured temperature data may presented via the I/O interface 118. Other embodiments are also possible.

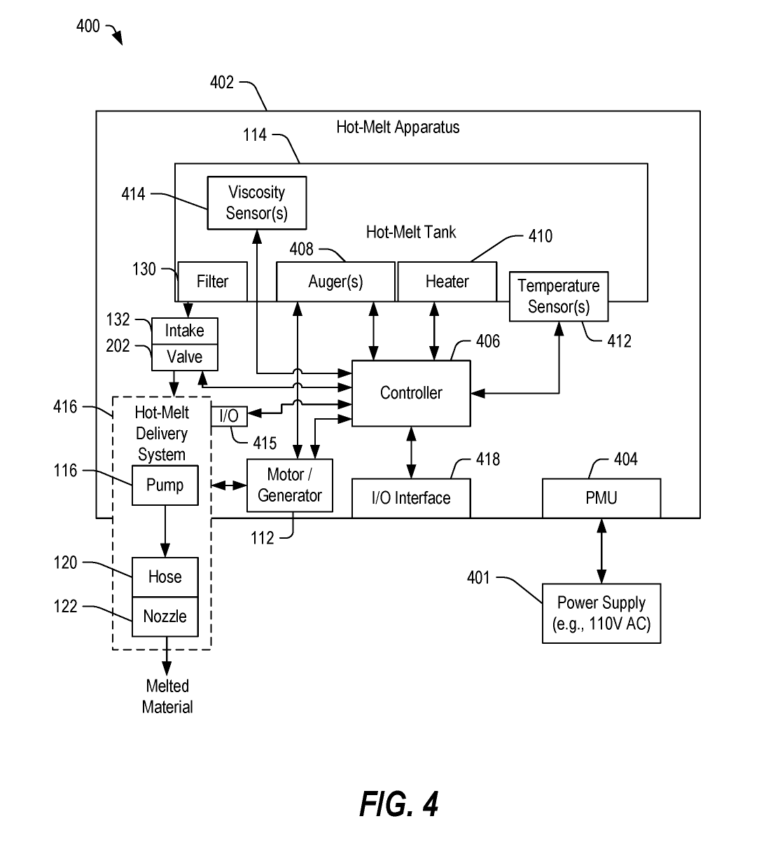

FIG. 4 is a block diagram of a hot-melt system 400 including a hot-melt apparatus 402 configured to distribute a thermo-melt material, in accordance with some embodiments of the present disclosure. The apparatus 402 may be an embodiment of the apparatus 100 of FIG. 1, the apparatus 200 in FIG. 2, or the apparatus 300 in FIG. 3. The apparatus 202 may be coupled to a power supply 401 and may be coupled to a nozzle 122 via a dispensing hose 120. The apparatus 402 may include a power management unit 404 coupled to the power supply 401 and configured to supply power to one or more components of the apparatus 400. In some embodiments, the power supply 401 may be a 110 Volt alternating current power supply, such as a standard power plug in the United States.

The apparatus 402 may include an I/O interface 418, which may include a touchscreen, buttons, switches, light-emitting diodes, a liquid crystal display, other elements, or any combination thereof, which may be configured to receive user selections and to provide information to a user. In some embodiments, the hot-melt apparatus 402 may be controlled by interacting with one or more selectable elements associated with the I/O interface 418.

The hot-melt apparatus 402 may also include the hot-melt tank 114. The apparatus 402 may further include a controller 406 coupled to the I/O interface 418, to a motor/generator 112, to the valve 212, to the hot-melt tank 114, and to a hot-melt delivery system 416. The hot-melt delivery system 416 may include the pump 116. The apparatus 402 may include a heater element 410 coupled to the controller 406 and may include one or more augers 408 to stir hot-melt material within the hot-melt tank 114. The apparatus 402 may further include one or more temperature sensors 412 coupled to the controller 406 and may include one or more viscosity sensors 414 coupled to the controller 406. The hot-melt tank 114 may include a filter 130 to prevent unmelted material from clogging the intake 132, the valve 202 or other elements of the hot-melt delivery system 416. The filter 130 may be a passive filter, which may In some embodiments, the auger 408 and the heater element 410 may be embodiments of the auger 115 and the heating element 113 of FIGS. 1-2.

In some embodiments, hot-melt material may be placed in the hot-melt tank 114, and a user may interact with one or more selectable elements of the I/O interface 418 to turn on the apparatus 402. In response to activation of one of the selectable elements, the apparatus 402 may draw power from the power supply 401. The controller 406 may cause the PMU 404 to provide power to the heater 410 and may monitor temperature measurements from the one or more temperature sensors 412 and from the one or more viscosity sensors 414. Further, the controller 406 may control the motor/generator 112 to activate the one or more augers 408 to stir the hot-melt material within the hot-melt tank 114. The controller 406 may monitor the viscosity of the hot-melt material via the one or more viscosity sensors 414 and may monitor the temperature of the hot-melt material using the one or more temperature sensors 412.

In some embodiments, the controller 406 may compare viscosity measurements to a viscosity threshold and may compare temperature measurements to one or more temperature thresholds. In some embodiments, viscosity may be determined from an amount of power required to turn the one or more augers 408. In some embodiments, the viscosity may be determined using viscometers. When at least one of the viscosity measurement and the temperature measurement exceeds a threshold, the controller 406 may determine that the hot-melt material is in a dispensable state (i.e., is sufficiently melted), and may cause the I/O interface 418 to provide a readiness indicator, such as a green light or a ready indicator.

Once the hot-melt material is ready to be dispensed, the controller 406 may enable the hot-melt delivery system 416, which may include the pump 116, the dispensing hose 120, and the nozzle 122. The user may interact with a trigger or switch associated with the nozzle 122 to selectively dispense the melted material (i.e., the fluidized hot-melt material) to an output of the nozzle 122. When the trigger is depressed, the melt material may be delivered through the dispensing hoze 120 to the nozzle 122 and through a dispensing tip to a substrate, such as a crack or expansion joint. The trigger of the hot-melt delivery system 416 may be coupled to the controller 406 via an input/output (I/O) interface 415. In response to signals from the I/O interface 415, the controller 406 may control the valve 202.

In some embodiments, the hot-melt delivery system 416 may include additional components, such as one or more heating elements to maintain a temperature of the hot-melt material within the dispensing hose 120 and the nozzle 122. In some embodiments, the controller 406 may include a timer to determine a period of time when the hot-melt fluid is not dispensed from the dispensing hose 120 and the nozzle 122. The pump 116 may be bi-directional and may be configured to reverse hot-melt fluid flow into the hot-melt tank 114 from the dispensing hose 120 and the nozzle 122 for re-heating if the hot-melt fluid is not dispensed within a period of time.

In some embodiments, a user may interact with the I/O interface 418 to program a hot-melt temperature for a selected hot-melt material. In some embodiments, the temperature settings (and the viscosity settings) may be configured via the I/O interface 418. Thus, the apparatus 402 may be utilized with different materials having different melt temperatures and different fluid viscosities.

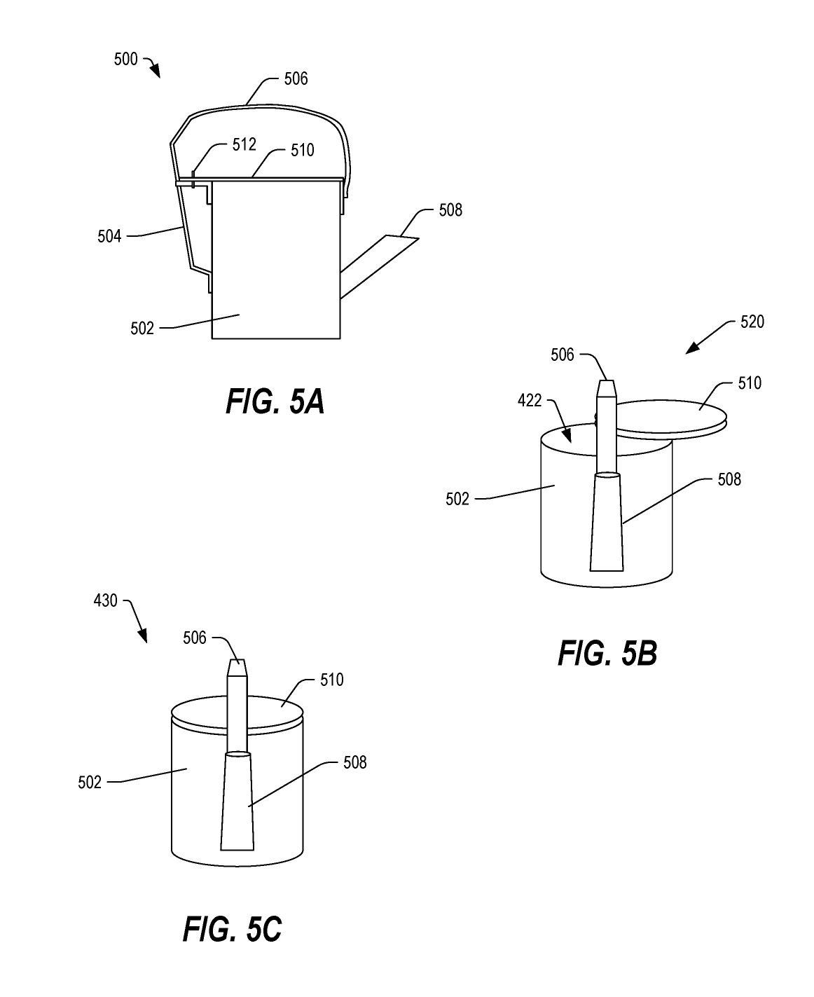

In the above-discussion, the hot-melt apparatus 400 may be moved via wheels. However, it is also possible to provide a smaller pour pot that may be carried and used to dispense the hot-melt material at selected locations. One possible example of a hand-held pour pot is described below with respect to FIGS. 5A-5C below.

FIG. 5A is a side-view of a pour pot 500 for distributing a thermo-melt material, in accordance with some embodiments of the present disclosure. The pour pot 500 may include a hot-melt tank 502 coupled to a handle having a first portion 504 and a second portion 506. The first portion 504 may be coupled to a first side of the reservoir 502, and the second portion may be coupled to a second side of the reservoir 502 opposite to the first side. The pour pot 500 may further include a pour spout 508 coupled to the reservoir 502 opposite to the first side and configured to provide a fluid flow conduit from the reservoir 502 to a tip of the pour spout 508. The pour pot 500 may further include a lid 510 coupled to one of the first portion 504 and the second portion 506 of the handle by a hinge element 512, such as a pin. In some embodiments, the lid 510 may operate as a closeable lid to selectively provide access to the reservoir 502 and to close off access to the reservoir 502.

FIG. 5B is a front view 520 of the pour pot 500 of FIG. 5A including a lid 510 in an open position, in accordance with some embodiments of the present disclosure. The lid 510 may be opened by pivoting the lid 510 about the hinge element 512. By pivoting the lid 510, the interior 522 of the reservoir 502 is exposed. A user may open the lid 510 and place hot-melt material into the interior 522.

In some embodiments, the user may place the pour pot 500 onto a heat source, such as a grill, a flame, another type of burner, or any combination thereof in order to heat the hot-melt material in the interior 522 of the reservoir 502. In some embodiments, the pour pot 500 may be made of metal, ceramic, or other material having a melt temperature that is greater than the melt temperature of the hot-melt material. In some embodiments, at least one of the first handle portion 504 and the second handle portion 506 may be formed of a different material from the reservoir 502. In some embodiments, at least the first portion 504 may be formed from or coated with a material that has low heat conductivity relative to the material used to form the reservoir 502. In a particular embodiment, the first portion 504 may be formed from metal and may include a cover portion, which may be made of a heat resistant material.

FIG. 5C is a front view 530 of the pour pot 500 of FIG. 5A including a lid 510 in a closed position, in accordance with some embodiments of the present disclosure. In some embodiments, the lid 510 may be moved to an open position, such as the position shown in the front view 520 of FIG. 5B in order to place hot-melt material into the interior 522 of the reservoir 502. Then, the lid 510 may be closed as shown in the front view 520 of FIG. 5C, and the pour pot 500 may be placed over a heat source to melt the hot-melt material.

In some embodiments, once the hot-melt material within the reservoir 502 is melted, the pour pot 500 may be carried to a crack or expansion joint, and the hot-melt material may be poured at the desired location. In some embodiments, the pour pot 500 may be re-heated several times, and hot-melt material may be added to the reservoir 502 in order to complete a job at a jobsite.

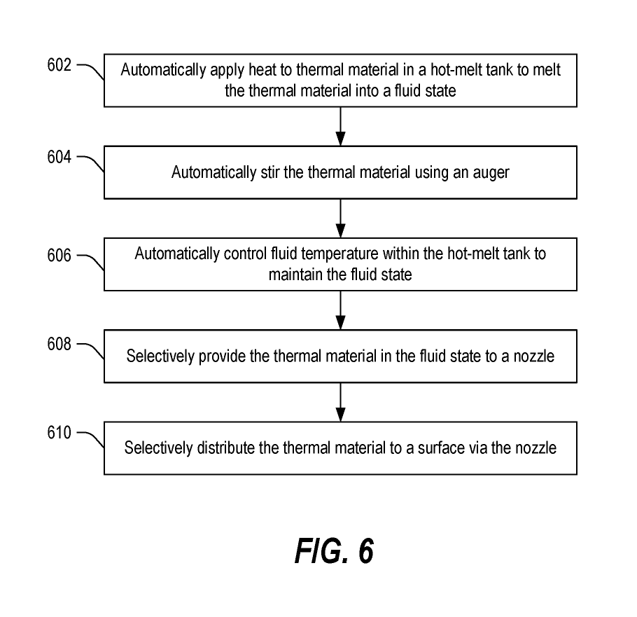

FIG. 6 is a flow diagram of a method 600 distributing a hot-melt material, in accordance with some embodiments of the present disclosure. At 602, the method 600 may include automatically applying heat to thermal material in a hot-melt tank to melt the thermal material into a fluid state. In some embodiments, the heat may be applied by a thermal element or heater associated with a hot-melt apparatus. In some embodiments, a controller of the apparatus may control the heater to maintain a temperature of the hot-melt material at a pre-determined temperature.

Continuing to 604, the method 600 may further include automatically stirring the thermal material using an auger. In some embodiments, instead of an auger, the thermal material may be stirred manually or may be stirred by a mixer element or other mechanism. Stirring of the thermal material as it is heated assists in distributing the heat and in melting the hot-melt material substantially uniformly.

Advancing to 606, the method 600 may include automatically controlling the fluid temperature within the hot-melt tank to maintain the fluid state. In some embodiments, a controller of a hot-melt apparatus may monitor the temperature measurements from one or more temperature sensors and may selectively control the heating element to maintain the temperature of the fluid. In some embodiments, instead of or in addition to monitoring the fluid temperature, the controller may monitor one or more viscosity measurements and may selectively control the heating element at least partially based on the viscosity measurements.

Proceeding to 608, the method 600 may include selectively providing the thermal material in the fluid state to a nozzle. In some embodiments, when the fluid temperature, the fluid viscosity, or both exceed respective thresholds, the controller may enable a hot-melt delivery system, such as a pump, to provide the hot-melt fluid to the nozzle (or other pour mechanism). In some embodiments, the controller may control and motor or an auger to drive the hot-melt fluid to the nozzle. In some embodiments, the controller, the pump, or the auger may provide the hot-melt material to the nozzle in response to selection of a selectable element associated with the nozzle. In some embodiments, the nozzle may include a trigger, a button, or another selectable feature in communication with the controller and configured to control flow of hot-melt material through the dispensing hose to the nozzle.

Moving to 610, the method 600 may include selectively distributing the thermal to a surface via the nozzle. In some embodiments, a user may interact with a trigger or other feature of the nozzle to control discharge of the hot-melt fluid. In some embodiments, in response to interaction with the trigger or other feature, the controller may cause the pump, the auger, or another feature to push the hot-melt fluid into the dispensing hose.

In conjunction with the apparatuses and methods described above with respect to FIGS. 1-6, a hot-melt apparatus and method are described in which hot-melt material, such as a hot-melt rubber sealant, may be melted and provided to a hot-melt dispensing system to allow a user to control dispensing of the hot-melt material. The hot-melt material may provide a self-leveling fluid flow that may bond to a substrate and flow and cool to form a substantially level and smooth surface. The hot-melt material may provide a seal between adjacent concrete slabs, within a crack, or between various materials. In some embodiments, depending on the quality of bond between the hot-melt material and the underlying substrate, the hot-melt material may cool to form a water tight seal, which may prevent fluid flow.

In some embodiments, a hot-melt apparatus may be provided that may be configured to apply heat to a hot-melt material and that may be configured to selectively deliver the hot-melt material to a nozzle for distribution at a selected location, such as a crack, an expansion joint, or another location. In some embodiments, the hot-melt apparatus may include an auger or another stirring mechanism to circulate the hot-melt fluid within a reservoir as it is being heated. In some embodiments, a controller may control a heating element associated with a hot-melt tank (or reservoir) to maintain a temperature of the hot-melt material at or above a melt temperature of the material. In some embodiments, the controller may adjust the heating element based on a viscosity measurement determined from a viscometer or from an amount of power used to turn an auger, and may selectively increase or decrease power to the heating element based on the viscosity. Other embodiments are also possible.

In the above-identified embodiments, embodiments of apparatus and associated methods for delivery of thermo-melt material to a substrate are described. The thermo-melt material may be provided in a variety of profiles, including a brick shape, a strip, a roll, a sheet, a stack of sheets, or another profile.

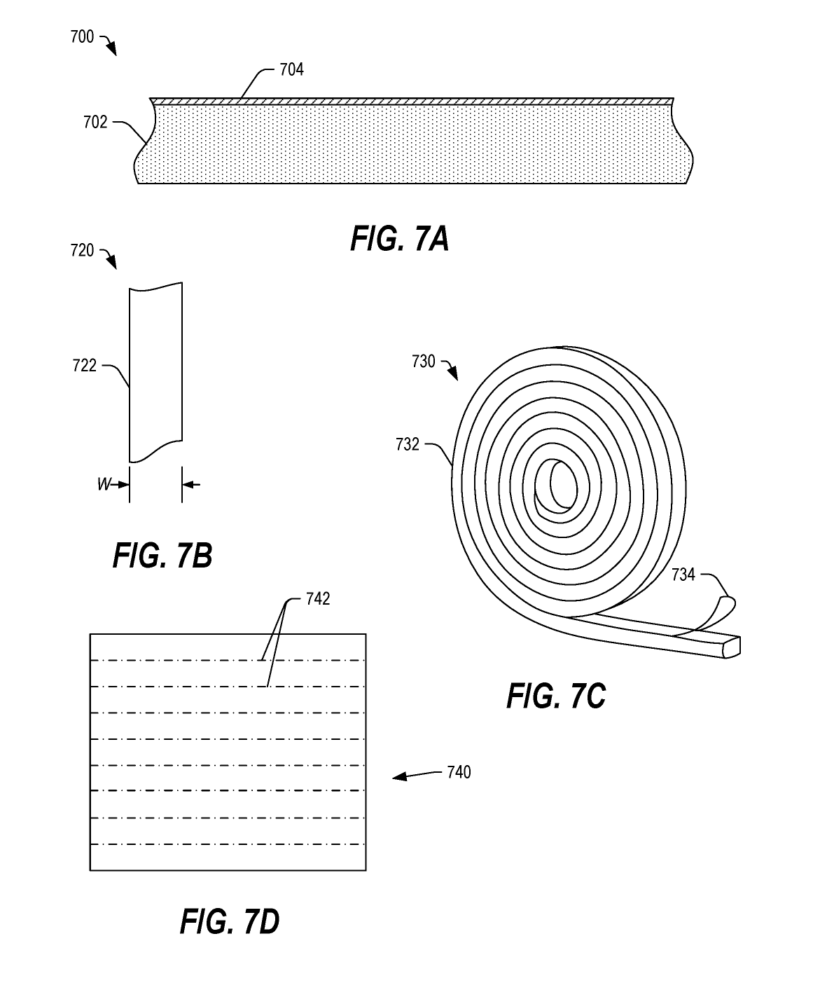

FIG. 7A is a cross-sectional view of a thermo-melt material 700, in accordance with some embodiments of the present disclosure. The thermo-melt material 700 may be used in the apparatuses and methods described above with respect to FIGS. 1-6. The thermo-melt material 700 may include a hot-melt rubber 702 and optionally a cover layer 704. In some embodiments, the cover layer 704 may be formed from flammable paper having a thermal threshold that is below the melt temperature of the hot-melt rubber 702. In some embodiments, the cover layer 704 may be omitted.

In an embodiment involving a brick-shaped profile, the cover layer 704 may be formed on an inside surface of a package, such as a cardboard box, and the hot-melt rubber 702 may be formed by the interior dimensions of the packaging. In another embodiment, the cover layer 704 may be used to wrap the brick-shaped profile of the hot-melt rubber 702. Other embodiments are also possible.

FIG. 7B is a top view 720 of a thermo-melt material 722 having a tape-strip profile, in accordance with some embodiments of the present disclosure. In some embodiments, the thermo-melt material 722 may be formed in a strip having a selected width (W). Depending on the implementation, the thermo-melt material 722 may be formed in a strip having a width of approximately half an inch, one inch, one and a half-inches, and so on. In some embodiments, the thermo-melt material 722 may be rolled up into a roll, as shown in FIG. 7C.

FIG. 7C is a side view of a roll 730 of thermo-melt material 732 having a tape-strip profile, in accordance with some embodiments of the present disclosure. The thermo-melt material 732 may be covered on one side by a cover layer 734, which may keep the thermo-melt material 732 from sticking to an adjacent layer.

In some embodiments, the thermo-melt material 732 may be unraveled from the roll 730 and the cover layer 734 may be peeled back and removed. The exposed thermo-melt material 732 may be pushed into a crack, an expansion joint, or another location, and the thermo-melt material 732 may be heated using a torch or another heat source to melt the thermo-melt material 732 into a liquid form, allowing the melted material to flow. In some embodiments, the thermo-melt material 732 may be unraveled from the roll and pushed into a crack, an expansion joint or another location with the cover layer 734 still attached. The thermo-melt material 732 may be heated with a torch or another heat source to burn the cover layer 734 and melt the thermo-melt material 732 into a liquid form.

FIG. 7D is a top view of a sheet 740 of thermo-melt material including perforations 742, in accordance with some embodiments of the present disclosure. The sheet 740 may include a cover layer, such as the cover layer 734 in FIG. 7C. The sheet 740 may be cut (by a user) along the perforation lines to achieve a desired width of the thermo-melt material 732 for use in a particular application. In some embodiments, the cover layer 734 may be peeled off. In other embodiments, the cover layer may be burned during a heating process that melts the thermo-melt material 732.

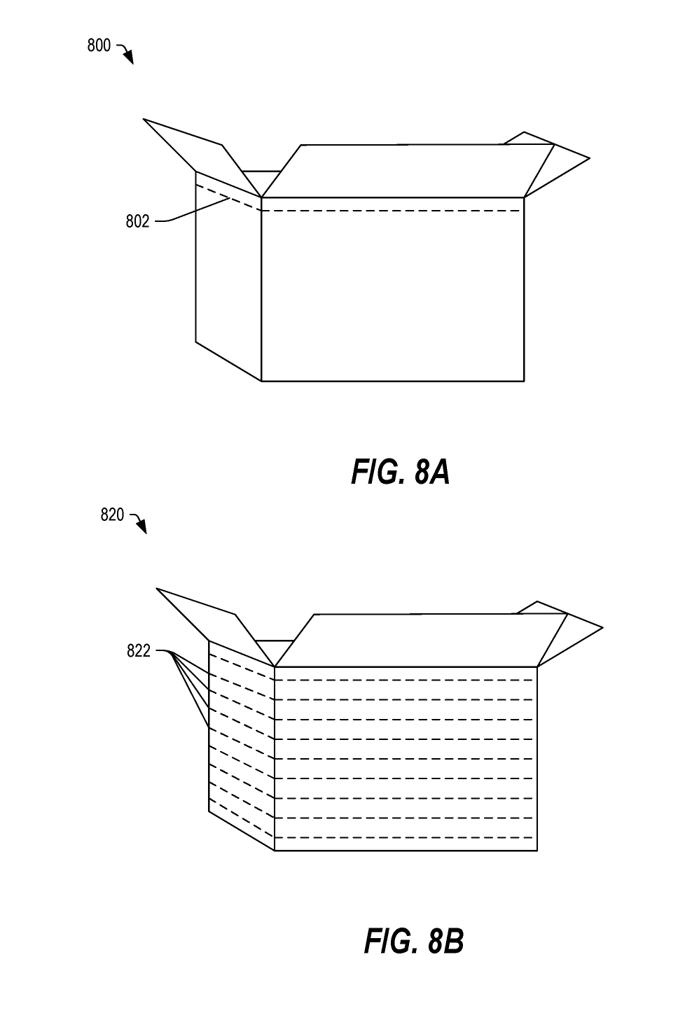

In some embodiments, the thermo-melt material may be formed into a brick form or another shape profile. The brick may be formed in a lined box or another container, which may be peeled back or otherwise adjusted to extract the thermo-melt material. One possible example of a brick of thermo-melt material is described below with respect to FIG. 8A.

FIG. 8A is a perspective view of a box 800 having a non-stick liner and including thermo-melt material, in accordance with some embodiments of the present disclosure. The thermo-melt material may be melted and poured into the box 800 and the material may harden to form a thermo-melt brick, the top of which is indicated by the dashed line 802.

FIG. 8B is a perspective view of a box 820 having a non-stick liner and including multiple layers of thermo-melt material, in accordance with some embodiments of the present disclosure. The multiple layers are indicated by dashed lines 822, and each layer may be separated from an adjacent layer by a cover layer, as described above with respect to FIGS. 7A-7D.

In conjunction with the apparatuses, methods, and hot-melt material described above with respect to FIGS. 1-8B, hot-melt rubber may be melted and poured into a crack, an expansion joint, or into another location. The material may flow, self-level, and then cool and harden to form a water-tight seal. In some embodiments, the hot-melt rubber may be unrolled, cut, or otherwise formed and may be placed into the crack, expansion joint, or other location, and the material may be heated in situ. Apparatuses described above may include a hot-melt tank, a pump, and a nozzle to melt the thermo-melt material into a fluid state and then to deliver the melted material to a selected location. In some embodiments, the nozzle and an associated delivery features (such as a hose or tube) may include one or more heating components to prevent the hot-melt material from cooling within the delivery system. The pump may be bi-directional and may be configured to draw the material from the nozzle and the delivery system components if the hot-melt material is not dispensed within a period of time.

Although the present invention has been described with reference to preferred embodiments, workers skilled in the art will recognize that changes may be made in form and detail without departing from the scope of the invention.

What is claimed is:

1. An apparatus comprising:
a frame including at least two wheels and a handle;
a tank mounted to the frame and configured to melt a hot-melt material;
a hot-melt delivery system coupled to the tank and configured to selectively deliver the hot-melt material in a fluid form to an output; and
a filter configured to prevent solid material from entering the hot-melt delivery system.

2. The apparatus of claim 1, further comprising:
a heating element associated with the hot-melt tank; and
a controller coupled to the heating element.

3. The apparatus of claim 2, further comprising an input/output interface including one or more user-selectable elements accessible to activate the heating element and to interact with settings of the controller.

4. The apparatus of claim 3, wherein:
the settings of the controller include a temperature threshold; and
the controller is configured to adjust the heating element to maintain a temperature of the hot-melt material at a level that is at or above the temperature threshold.

5. The apparatus of claim 3, wherein the input/output interface includes at least one of a display and a touchscreen element.

6. The apparatus of claim 2, further comprising at least one of a temperature sensor and a viscosity sensor coupled to the tank and to the controller.

7. The apparatus of claim 6, wherein the controller is configured to enable the hot-melt delivery system when a temperature measurement of the temperature sensor exceeds a temperature threshold.

8. The apparatus of claim 6, wherein the controller is configured to enable the hot-melt delivery system when a viscosity measurement of the viscosity sensor exceeds a viscosity threshold.

9. The apparatus of claim 1, wherein the hot-melt delivery system comprises:
a valve coupled to the controller and to the tank;
a pump coupled to the tank;
a nozzle; and
a dispensing tube coupled between the valve and the nozzle.

10. The apparatus of claim 9, further comprising a heating element coupled to at least one of the dispensing tube and the nozzle.

11. The apparatus of claim 9, wherein, when the hot-melt material is not dispensed from the nozzle within a period of time, the controller is configured to send a signal to the pump to reverse a flow of the hot-melt material from the dispensing tube into the tank.

12. The apparatus of claim 1, further comprising a power management circuit configured to receive a 110 Volt AC power supply and to provide power to at least one of the heating element, the controller, and the hot-melt delivery system.

13. The apparatus of claim 1, further comprising a holster coupled to the frame and configured to secure a nozzle of the hot-melt delivery system when not dispensing hot-melt material.

14. An apparatus comprising:
a frame including at least two wheels and a handle, the frame configured to be portable;
a tank coupled to the frame and configured to hold a hot-melt material in a fluid form;
a filter disposed within the tank and configured to separate solid material from the hot melt material in the fluid form; and
a hot-melt delivery system coupled to the tank and configured to selectively provide the hot-melt material to a substrate.

15. The apparatus of claim 14, further comprising a lid configured to open and close access to the hot-melt tank.

16. The apparatus of claim 14, wherein the hot-melt delivery system comprises:
a nozzle;
a dispensing tube coupled to the hot-melt tank at a first end and to the dispensing nozzle at a second end; and
a pump configured to force the hot-melt material in the fluid form into the dispensing tube.

17. The apparatus of claim 14, further comprising:
a heating element coupled to the hot-melt tank; and
a power management circuit configured to receive a 110V alternating current power supply and to provide a power supply to the heating element.

18. An apparatus comprising:
a frame including at least two wheels and a handle, the frame configured to be portable;
a tank coupled to the frame and configured to hold a hot-melt material in a fluid form, the tank including a heating element and one or more sensors;
a hot-melt delivery system coupled to the tank and configured to selectively provide the hot-melt material to a substrate; and
a controller coupled to the heating element, the one or more sensors, and the hot-melt delivery system, the controller configured to selectively enable the hot-melt delivery system when the hot-melt material reaches at least one of a selected temperature and a selected viscosity.

19. The apparatus of claim 18, further comprising:
an input/output interface coupled to the controller and including at least one indicator; and
wherein the controller is configured to send a signal to enable the at least one indicator when the hot-melt material reaches at least one of a selected temperature and a selected viscosity.

20. The apparatus of claim 18, wherein the hot-melt delivery system comprises:
a nozzle;
a dispensing tube coupled to the hot-melt tank at a first end and to the dispensing nozzle at a second end;
a pump configured to deliver the hot-melt material in the fluid form into the dispensing tube; and
a heating element coupled to at least one of the nozzle and the dispensing tube.
